(19) United States
(12) Patent Application Publication
(10) Pub. No.: US 2010/0201117 A1
(43) Pub. Date: Aug. 12, 2010

(54) GALVANIC CORROSION PROTECTIVE PIPING CONNECTION

(76) Inventor: Michael LIN, Livingston, NJ (US)

Correspondence Address: DUANE MORRIS LLP - Philadelphia;IP DEPARTMENT, 30 SOUTH 17TH STREET, PHILADELPHIA, PA, 19103-4196, US

(21) Appl. No.: 12/516,528

(22) PCT Filed: Nov. 28, 2007
(86) PCT No.: PCT/US2007/085792

§ 371 Date: Apr. 12, 2010

(30) Foreign Application Priority Data
Nov. 28, 2006 (CN) 200620150042.4
Jan. 19, 2007 (CN) 200720095006.7

(51) Int. Cl. F16L 21/00

(52) U.S. Cl. 285/53

(57) ABSTRACT

A piping connector having a crimp section configured to snugly fit around an external diameter of a pipe, the crimp section having one of a flared and an unflared edge, and a galvanic shield connected to the crimp section, wherein the galvanic shield covers a exterior diameter of a pipe end to be connected and frontal face of the pipe end, wherein a joint between the crimp section and the galvanic shield is one of a chemical connection and a mechanical connection.

### FIELD OF THE INVENTION

The present invention relates to piping connections. More specifically, the present invention provides a piping connection that provides a secure connection between the individual piping sections to be joined, while protecting against galvanic corrosion between different materials used in the pipe connection.

### BACKGROUND INFORMATION

Connection of piping is an important function in creating a piping system. Piping systems may be used for mass transport for materials, such as fluids and gases. These piping systems may be manufactured of differing materials such as, plastic, iron, copper or other similar materials. These materials, however, can cause problems, especially when the materials themselves are mixed. When different stainless materials are mixed together (as dictated by the needs of the piping system), the differing materials cause a galvanic reaction, compromising the piping over time.

Conventional techniques used for establishing pipe connections include various crimping technologies that exert tremendous force upon the ends of piping but have a limited effect on providing a leak-free seal. Such connections often include provision of a spool piece inside the inner diameter of piping sections to be joined, wherein the outer piping system is then crimped around the spool piece to provide a mechanical connection.

Although well intentioned, the conventional techniques used for creation of piping connections have significant drawbacks. First and foremost, these conventional techniques do not allow account for galvanic reactions that are created when different metallic materials are used in a piping connection. These galvanic reactions lead to failure of the piping system over time. Another significant drawback includes inappropriate crimp of the piping system that in turn allows materials to escape from the system. Large and expensive crimping tools must be used to establish these connections which is a significant drawback during fabrication of the piping system. To overcome these significant drawbacks, other conventional techniques include soldering and\or welding of pipe sections together that in turn causes increased costs for fabrication of the system.

There is therefore a need to provide a mechanical connection that will allow for connection of differing materials to prevent galvanic corrosion of the established connection.

There is a further need to provide a mechanical connection that will connect different sections of the piping system in an economical manner.

There is a still further need to provide a mechanical connection that may be installed in a piping system with a simple crimping tool, that will not require special training for operation.

There is still further need to provide such a mechanical connection that is economical to produce and store to allow large scale connections of piping, tubing and other mass transport members.

### SUMMARY OF THE INVENTION

It is therefore an objective of an aspect of the present invention to provide a mechanical connection that will allow for connection of differing materials to prevent galvanic corrosion of the established connection.

It is also an objective of an aspect of the present invention to provide a mechanical connection that will connect different sections of the piping system in an economical manner.

It is a further objective of an aspect of the present invention to provide a mechanical connection that may be installed in a piping system with a simple crimping tool, that will not require special training for operation.

Is a still further objective of an aspect of the present invention to provide such a mechanical connection that is economical to produce and store to allow large scale connections of piping, tubing and other mass transport members.

The objectives of the present invention are achieved as illustrated and described. In an exemplary embodiment of the present invention, a piping connector is presented comprising, a crimp section configured to snugly fit around an external diameter of a pipe, the crimp section having one of a flared and an unflared edge, and a galvanic shield connected to the crimp section, wherein the galvanic shield covers a exterior diameter of a pipe end to be connected and frontal face of the pipe end, wherein a joint between the crimp section and the galvanic shield is one of a chemical connection and a mechanical connection.

In an alternative exemplary embodiment, the piping connector as described above is provided wherein the joint between the crimp section and the galvanic is a mechanical tab arrangement.

In another alternative exemplary embodiment, the piping connector is provided such that the galvanic shield is made of plastic. In another alternative exemplary embodiment, the piping connector may be made of a high temperature plastic.

In a further exemplary embodiment, the piping connector is provided such that the crimp section is made of one of stainless material, copper and a deformable metallic material.

In another exemplary embodiment of the invention, a method is provided to connect at least two pieces of pipe, wherein the pipe pieces connected do not have a galvanic reaction. This method comprises placing a galvanic shield with an attached crimp section over an end of a first piece of pipe, inserting a spool piece into the abutment end such that the spool piece only contacts an interior portion of the first piece of pipe and the galvanic shield, and crimping the crimp section to deform the crimp section and the piping around the spool piece, wherein the crimp section is configured to snugly fit around an external diameter of the first piece of pipe, the crimp section having one of a flared and an unflared edge, and the galvanic shield connected to the crimp section, wherein the galvanic shield covers an exterior diameter of a pipe end to be connected and frontal face of the pipe end and wherein a joint between the crimp section and the galvanic shield is one of a chemical connection and a mechanical connection

In another exemplary embodiment, the method may be accomplished such that the joint between the crimp section and the galvanic is a mechanical tab arrangement. The galvanic shield may be made of a plastic material, or in particular a high temperature resistant plastic.

In another exemplary embodiment of an aspect of the invention, the method above is performed such that the crimp section is made of one of stainless material, copper and a deformable metallic material.

In another exemplary embodiment of the present invention, the spool piece has a ridged surface.

### BRIEF DESCRIPTION OF THE DRAWINGS

FIG. 1 is a front view of a piping connector in accordance with an exemplary embodiment of the invention.

FIG. 2 is a side view of the piping connector of FIG. 1.

FIG. 3 is a flow chart of a method for connecting two different pipes together with a piping connector of FIG. 1.

### DETAILED DESCRIPTION

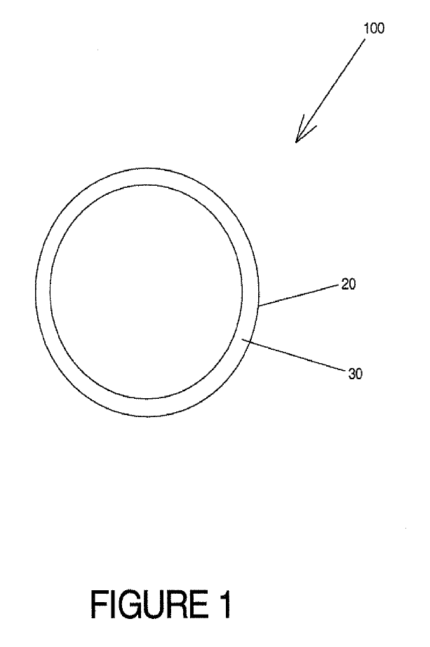

Referring to FIG. 1, a front view of a piping connector 100 is illustrated. In this front view a galvanic shield 20 is provided. The galvanic shield 20 prevents galvanic interaction between materials of differing components thus preventing corrosion from occurring. Unchecked corrosion, may lead to degradation of the piping system and is an undesirable feature of conventional piping systems. In the present invention, however, the galvanic shield 20 prevents contact between differing metallic parts of a piping system and therefore prevents corrosion from occurring. The galvanic shield 20 is provided on an end of a pipe such that a spool piece may be inserted into the pipe and the pipe crimped to establish a connection between the pipe and the spool piece. The galvanic shield 20 may be made of any material to prevent galvanic reaction from occurring between the differing metallic components of the connection. In the illustrated embodiment provided, the material is a high temperature resistant plastic. The galvanic shield 20, however, may be made of copper if a copper piping system is to be created. The galvanic shield 20 can be chosen to be a material identical to that of the piping system or may be a nonconducting material to prevent galvanic corrosion from occurring.

In the illustrated embodiment provided in FIG. 1, a front face 30 of the galvanic shield 20 is provided. The front face 30 of the galvanic shield 20 prevents contact between the piping system and a spool piece placed within the piping system except for an internal connection point that is established through crimping (described later). The front face 30 of the galvanic shield 20 therefore can extend across the entire face of an open pipe.

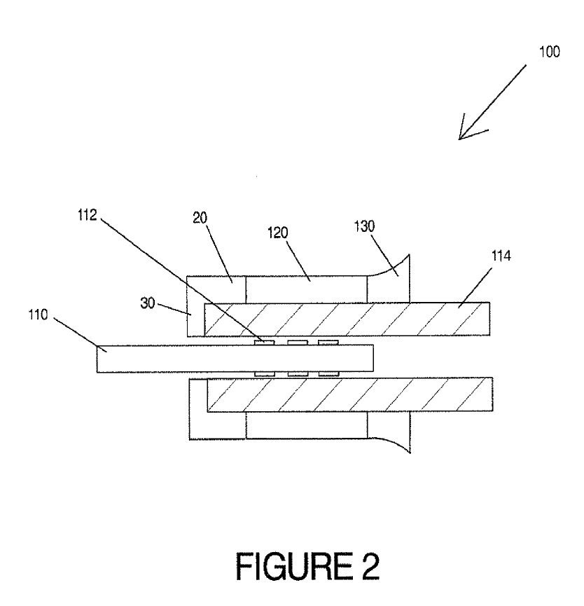

Referring to FIG. 2, a piping connector 100 is illustrated in the process of being installed upon a pipe 114. The piping connector 100 is composed of two sections, a crimp section 120 and a galvanic shield 20. A connection is established between the galvanic shield 20 and the crimp section 120 such that the two sections act in unison. At the posterior end of the crimp section 128, a flared edge 130 is positioned. The flared edge 130 allows the piping connector 100 to be installed upon an open ended pipe 114 quickly and efficiently, allowing the piping connector 110 to be installed by merely slipping the pipe 114 up through the piping connector 100 to the back of the front face 30. Although illustrated as a squared inside edge for the flared edge 130, the inside edge may also be flared providing a smooth surface for insertion of the open ended pipe 114.

After the pipe 114 is fully inserted into the piping connector 100 through the flared end 130 the pipe will contact the inside of the front face 30 and stop. After the pipe 114 can no longer be inserted into the piping connector 100, a spool piece 210 is inserted into the open portion of the front face 30 of the galvanic shield 20. The spool piece 210 allows for a mechanical connection to be established between the inside diameter of the pipe 114 and ridges 112 placed along the spool piece 210. To establish the mechanical connection between the pipe 114 and the spool piece 210, an installer uses a crimping cool that provides a circumferential force upon the crimp section 120 of the piping connector 100. When sufficient force is exerted on the crimp section 120, the crimp section 120 deforms uniformly around the external diameter of the pipe 114. The deformation of the crimp section 120 causes the pipe 114 to contract and therefore deform according to the amount of force exerted by the crimp section 120. The deflection of the pipe 114 toward the center axis of the pipe system eventually causes a contact between the inside of the pipe 114 and the ridges 112 of the spool piece 210.

A connection between the galvanic shield 20 and the crimp section 120 allows for the sum total of the piping connection 100 to act as a unitary element. To this end, the galvanic shield 20 is connected to the crimp section 120 through a mechanical or chemical connection. In the illustrated embodiment, the connection is a mechanical connection to allow the galvanic shield 20 to snap together with the crimp section 120. A tabbed arrangement or a slotted connection may be used to connect the galvanic shield 20 with the crimp section 120. The crimp section may configured from a stainless material, as a non-limiting example. Other examples include forming the crimp section 120 from a deformable plastic material sufficient to transfer force from the crimping tool to the piping system.

In order to allow for a tight fit of the spool piece 210 inside the inner diameter of the pipe 114, the front face 30 of the galvanic shield 20 may be formed to provide a snug fit around the spool piece 210 when inserted through the open diameter of the galvanic shield 20.

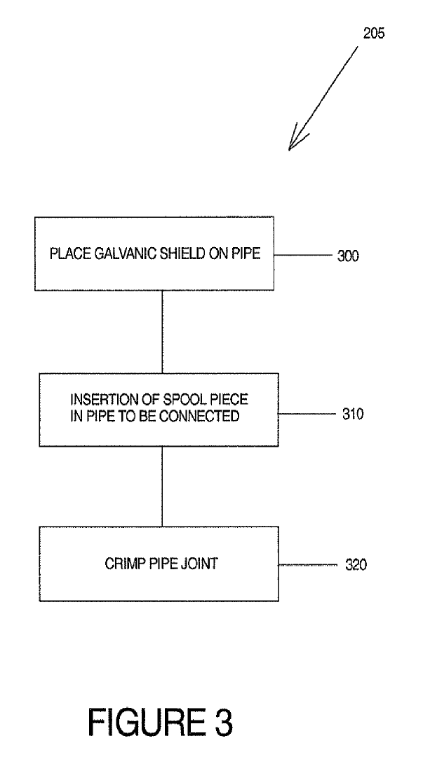

Referring to FIG. 3, a method 205 to connect at least two pieces of pipe, wherein the pipe pieces connected do not have a galvanic reaction is presented. In the first step 300, a galvanic shield 20 provided with an attached crimp section 120 over an end of a first piece of pipe 114. As described above, the unitary piece of the galvanic shield 20 and the crimp section 120 are connected such that they may be easily placed upon the end. Next, a spool piece is inserted into the abutment end such that the spool piece only contacts an interior portion of the first piece of pipe and the galvanic shield 310. Next, the crimp section is crimped 320 such that the crimp section is deformed and the piping around the spool piece 210, wherein the crimp section 120 is configured to snugly fit around an external diameter of the first piece of pipe, the crimp section 120 having one of a flared and an unflared edge, and the galvanic shield 20 connected to the crimp section 120, wherein the galvanic shield 20 covers an exterior diameter of a pipe end to be connected and frontal face of the pipe end and wherein a joint between the crimp section and the galvanic shield is one of a chemical connection and a mechanical connection. The crimp tool may be a simple mechanical unit designed to uniformly place a circumferential pressure around the crimp section such that the crimp section is uniformly deformed.

The present invention provides a mechanical connection that will connect different sections of a piping system. As provided, multiple pieces of pipe may be connected through the mechanical connection provided such that if a hub of spool pieces is used, more than two pipe sections may be joined. Piping, tubing and other mass transport members may be connected through the method and apparatus provided.

The present invention also provides a mechanical connection that will allows a relatively unskilled individual to quickly connect different sections of the piping system. The method and apparatus provided, eliminates the need for expensive welding of piping systems while preventing corrosion of the established connection, different than even welded connections.

The present invention provides a mechanical connection that may be installed in a piping system with a simple crimp tool placed over the crimp section of the apparatus. The crimp section allows for quick connection of spool pieces to the piping system, thereby economically saving installers economic expense.

The present invention also provides a simple connection for use in a piping system that may be used by installers without the need for special training, thereby allowing less skilled laborers the opportunity to quickly and efficiently install piping systems.

What is claimed is:

1. A piping connector, comprising:
a crimp section configured to snugly fit around an external diameter of a pipe, the crimp section having one of a flared and an unflared edge; and
a galvanic shield connected to the crimp section, wherein the galvanic shield covers a exterior diameter of a pipe end to be connected and frontal face of the pipe end, wherein a joint between the crimp section and the galvanic shield is one of a chemical connection and a mechanical connection.

2. The piping connector according to claim 1, wherein the joint between the crimp section and the galvanic is a mechanical tab arrangement.

3. The piping connector according to claim 1, wherein the galvanic shield is made of plastic.

4. The piping connector according to claim 3, wherein the plastic is a high temperature plastic.

5. The piping connector according to claim 1, wherein the crimp section is made of one of stainless material, copper and a deformable metallic material.

6. A method to connect at least two pieces of pipe, wherein the pipe pieces connected do not have a galvanic reaction, comprising:
placing a galvanic shield with an attached crimp section over an end of a first piece of pipe;
inserting a spool piece into the abutment end such that the spool piece only contacts an interior portion of the first piece of pipe and the galvanic shield; and
crimping the crimp section to deform the crimp section and the piping around the spool piece, wherein the crimp section is configured to snugly fit around an external diameter of the first piece of pipe, the crimp section having one of a flared and an unflared edge, and the galvanic shield connected to the crimp section, wherein the galvanic shield covers an exterior diameter of a pipe end to be connected and frontal face of the pipe end and wherein a joint between the crimp section and the galvanic shield is one of a chemical connection and a mechanical connection

7. The method according to claim 6, wherein the joint between the crimp section and the galvanic is a mechanical tab arrangement.

8. The method according to claim 6, wherein the galvanic shield is made of plastic.

9. The method according to claim 6, wherein the plastic is a high temperature plastic.

10. The method according to claim 6, wherein the crimp section is made of one of stainless material, copper and a deformable metallic material.

11. The method according to claim 6, wherein the spool piece has a ridged surface.
